(19) United States
(12) Patent Application Publication
(10) Pub. No.: US 2022/0374737 A1
(43) Pub. Date: Nov. 24, 2022

(54) MULTI-DIMENSIONAL MODELING OF DRIVER AND ENVIRONMENT CHARACTERISTICS

(71) Applicant: MOTIVE TECHNOLOGIES, INC., San Francisco, CA (US)

(72) Inventors: Raghu V. DHARA, Fremont, CA (US); Shravan SUNKADA, Kensington, CA (US); Christopher CHEN, San Francisco, CA (US); John SEARS, Berkeley, CA (US)

(21) Appl. No.: 17/328,451

(22) Filed: May 24, 2021

(51) Int. Cl. G06N 5/04; G06N 20/00; G07C 5/00; G06F 16/29

(52) U.S. Cl. CPC G06N 5/04; G06N 20/00; G07C 5/008; G06F 16/29

(57) ABSTRACT

The disclosed embodiments provide techniques for scoring a driver or vehicle. In one embodiment, a method is disclosed comprising receiving metrics associated with a vehicle; generating a deviation vector based on the metrics and a plurality of aggregated values corresponding to the metrics; computing a driver update value based on the deviation vector and a plurality of model parameters, each of the plurality of model parameters corresponding to the metrics; and computing a driver score based on the driver update value, a previous score, and a learning rate.

### BACKGROUND

The disclosed embodiments are directed toward modeling the activities of automobiles and drivers and, in particular, toward developing a comprehensive representation of the safety of a vehicle and driver for segments of roadways.

Current systems attempt to rate driver behavior based on rudimentary data collection and processing. Such systems primarily gather data regarding driver behavior, aggregate such behavior, and generate a score. For example, a system may record the number of hard brakes, accelerations, and corners and apply various basic algebraic operations to this data to determine a score.

Such systems fail to account for the context in which these raw events occur. For example, if all drivers perform hard brakes on a given segment of a road (e.g., due to roadway geometry), a driver that likewise performs a hard brake should not be penalized harshly due simply to the execution of a hard brake. Currently, no such scores can account for these contextual factors.

### BRIEF SUMMARY

The disclosed embodiments solve these and other problems by providing a finer-grained driver or vehicle safety score. The disclosed embodiments assess the behavior of a driver using more than telematic events and provide true visibility into the characteristics of a driver or vehicle. The disclosed embodiments use raw telematics data as an input to a system that contextualizes behavior based on expected behavior on a per-segment basis of a roadway.

The disclosed embodiments capture driver, road, imaging, vehicle, and environmental contexts of a specific driver, segment, and action. First, the system records driver data in the form of, for example, speed data, hard braking, hard acceleration, hard cornering, legal violations, driver fatigue, etc. The system stores road and segment data, which aggregates data across multiple drivers to build a model of expected behavior on a roadway. Imaging data is further collected, which can detect internal and external events such as road obstructions, tailgating, distracted driving, etc. A vehicle database stores class, make, model, and similar data regarding the underlying vehicles generating the vehicle data. Finally, environmental data such as time of day, road conditions, etc., are also considered when producing a single driver or vehicle score.

Scores generated using the disclosed embodiments accurately and actionably surface insights and metrics for drivers and operators alike to understand, monitor, and improve their driving risk profiles. The disclosed scores take a variety of features into account and ultimately produce a numerical score (e.g., an integer between 1 and 100). In some embodiments, the larger the number, the safer the driver is deemed to be. In some embodiments, the disclosed scores can be used by downstream applications such as fleet scoring, fleet benchmarking, and artificial intelligence coaching engines.

### BRIEF DESCRIPTION OF THE DRAWINGS

FIG. 1 is a diagram of a road network according to some embodiments of the disclosure.

FIG. 2 is a database diagram of roadway data according to some embodiments of the disclosure.

FIG. 3 is a diagram of a road network and driver paths according to some embodiments of the disclosure.

FIG. 4 is a database diagram of two columns of a roadway data table according to some embodiments of the disclosure.

FIG. 5 is a database diagram of two driver paths and a view of a roadway data table according to some embodiments of the disclosure.

FIG. 6 is a database diagram of two driver paths and a view of a roadway data table according to some embodiments of the disclosure.

FIG. 7 is an illustration of a graphical user interface (GUI) for displaying roadway data according to some embodiments of the disclosure.

FIG. 8 is a flow diagram illustrating a method for continuously updating a driver or vehicle score according to some embodiments of the disclosure.

FIG. 9 is a block diagram of a system for computing a driver score according to some embodiments of the disclosure.

FIG. 10 is a block diagram illustrating a computing device showing an example of a client or server device used in the various embodiments of the disclosure.

FIG. 11 is a block diagram of a vehicle according to some embodiments of the disclosure.

### DETAILED DESCRIPTION

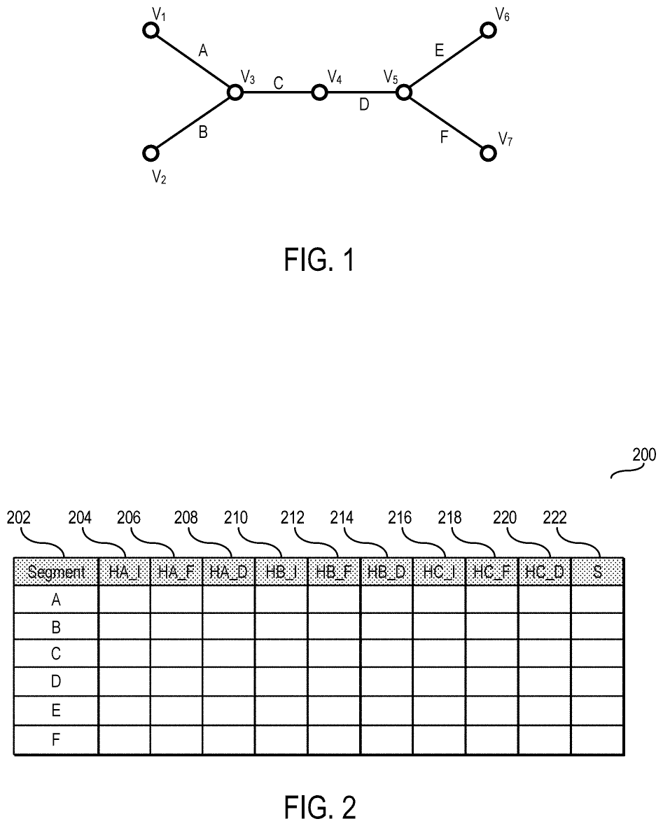

FIG. 1 is a diagram of a road network according to some embodiments of the disclosure.

In the illustrated embodiment, a roadway includes a plurality of segments (A-F). Each segment is associated with at least two vertices (e.g., v₁-v₇). Thus, any roadway can be constructed as a graph. As illustrated, in some embodiments, this graph is undirected. Alternatively, in other embodiments, the graph may be directed. In these embodiments, the direction of segments (A-F) may correspond to a flow of traffic along the roadway.

In some embodiments, each segment may represent multiple lanes. For example, segment (A) may comprise a multi-lane highway segment including two eastbound lanes and two westbound lanes. In an undirected graph, a single line segment can be used to represent this segment. In some embodiments, if a directed graph is used, lanes in one direction (e.g., eastbound) may be represented in a first directed graph, while lanes in the other direction (e.g., westbound) may be represented in a second directed graph. However, for purposes of illustration, undirected graphs are presented to ease understanding. In general, the choice of graph type may be determined based on the needs of the implementation, and the disclosed embodiments are not limited to a specific graph type or topology.

In some embodiments, the vertices (v₁-v₇) may correspond to physical junctions. For example, vertex (v₃) may comprise a T-junction between roadways corresponding to segment (A), segment (B), and segment (C). In other embodiments, the vertices (v₁-v₇) may correspond to larger geographic landmarks such as cities or towns. However, the disclosed embodiments are not limited in this manner. For example, the vertices (v₁-v₇) may comprise arbitrary points along a roadway. For example, vertex (v₄) may comprise an arbitrary point along a single stretch of highway comprising segment (C) and segment (D). For example, each roadway may be segmented into one- or two-mile segments. Thus, a given vertex may comprise a “mile marker” vertex that is not bound to a specific location or roadway feature. In this manner, roadways can be represented more granularly (i.e., by increasing the number of vertices and, by proxy, the number of segments) or less granularly (i.e., by decreasing the number of vertices and segments). As a non-limiting example, each segment may comprise short sections (e.g., 50 feet) of a roadway. The decision regarding which granularity to use can be determined based on the underlying processing and storage capacity of the system storing the road data as well as the effects of the granularity on overall model performance.

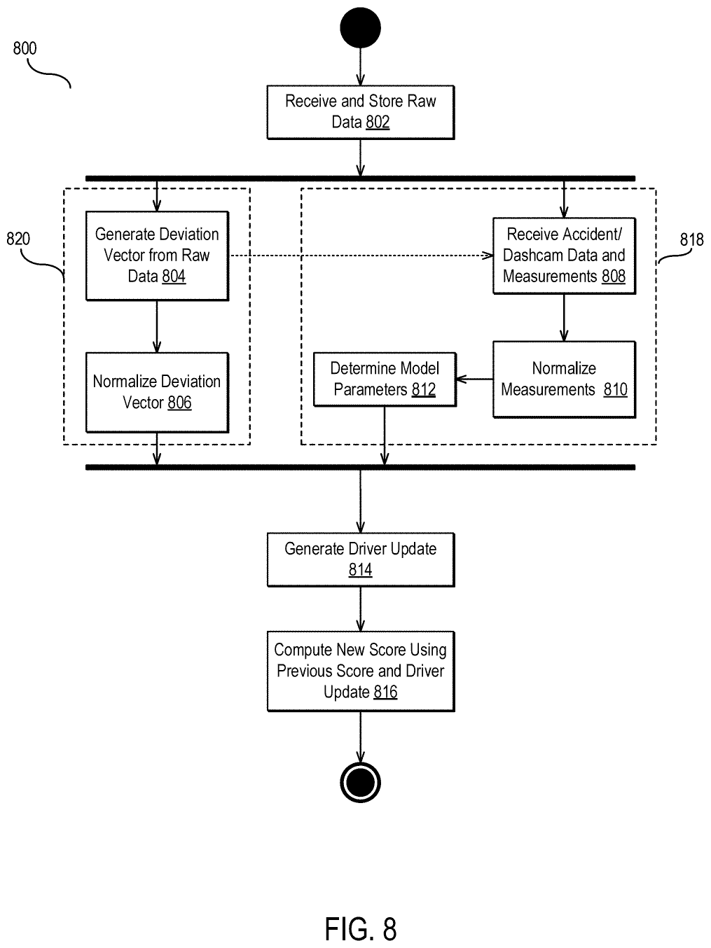

FIGS. 2 through 6 utilize the graph in FIG. 1 as an example roadway subject to modeling using the general techniques discussed in connection with FIG. 8. The examples provided below in FIGS. 2 through 6 are not limiting but are merely examples of the types of operations described in more detail FIG. 8.

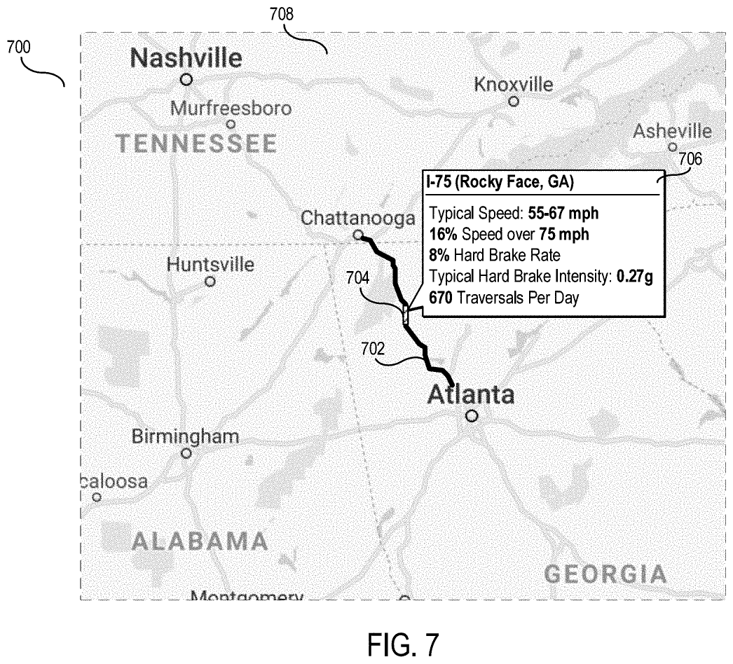

FIG. 2 is a database diagram of roadway data according to some embodiments of the disclosure. FIG. 7 is an illustration of a graphical user interface (GUI) for displaying roadway data according to some embodiments of the disclosure.

In the illustrated embodiment, the roadway modeled in FIG. 1 is represented in a relational database form, as depicted in FIG. 2. In the illustrated embodiment, a table (200) includes a plurality of columns and a plurality of rows.

Specifically, the columns include a segment column (202). In the illustrated embodiment, the segment column (202) stores the segment identifiers depicted, for example, in FIG. 1. Although alphabetical identifiers are used, any unique value may be used to identify a segment of the roadway. Since the roadway of FIG. 1 includes six segments (A-F), the table (200) includes six rows corresponding to each segment. Certainly, a production system would include significantly more rows than depicted and the embodiments are not limited to a specific number of rows.

The columns additionally include a HA_I column (204) that stores data representing the intensity of hard accelerations for a given segment. As used herein, a hard acceleration refers to an acceleration event with a telematic signature which is determined algorithmically to be an abnormally high positive longitudinal acceleration. In some embodiments, the value in the HA_I column (204) is measured in g-forces. In some embodiments, this value is measured by onboard electronics installed in a vehicle. In one embodiment, the onboard electronics may comprise built-in measurement systems (e.g., connected to a controller area network bus of the vehicle or built-in to a vehicle subsystem). In other embodiments, the electronics may comprise an after-market device for recording vehicle data. In some embodiments, an accelerometer may be used to measure hard accelerations in, for example, meters per second squared. Such electronics may continuously report the acceleration of the vehicle during operation and thus during driving on each of the segments (A-F). In some embodiments, when the onboard electronics detect a hard acceleration, they transmit a notification of this event to a centralized system maintaining the table (200). In one embodiment, the HA_I (206) column stores an aggregate measure (such as but not limited to the average value) of the hard acceleration intensity, which may also be considered, and in some instances referred to as, the expected value of hard acceleration intensity for that segment, and thus updates this per-segment aggregate value using the received values.

The table (200) additionally includes an HA_F column (206) that stores the frequency of hard acceleration events on a given segment of roadway. In some embodiments, a centralized system will monitor the number of hard acceleration events vehicles produce while operating on the road network and will accumulate the number of hard accelerations detected. The system will then update (with a potentially defined periodicity) the baseline for the frequency of hard accelerations for the segment.

The table (200) additionally includes an HA_D column (208) that stores the duration of hard acceleration events on a given segment of roadway. In the illustrated embodiment, the duration may be stored as an aggregate measure of the number of seconds that a hard acceleration event lasts on a roadway. As discussed above, the vehicle may report both the start and stop of a hard acceleration event to the centralized system. These events may include timestamps that the centralized system can use to compute the duration of a hard acceleration event. As with the HA_F column (206), the system accumulates hard acceleration events as drivers traverse various road segments over a period of time. Then, with a potentially variable periodicity, these accumulated values will be used to update the overall baseline for the computed aggregate duration of a hard acceleration for a given segment.

The table further includes an HB_I column (210), an HB_F column (212), and an HB_D column (214) storing hard braking intensity, frequency, and duration, respectively. Details of these columns are similar to that of the HA_I column (204), HA_F column (206), and HA_D column (208). Indeed, a hard braking intensity is also measured in meters per second squared (and subsequently may be converted to gs), and hard braking duration is also measured in seconds. However, while hard acceleration is an increase in velocity, hard braking is a decrease in velocity. Otherwise, the same techniques may be applied to monitoring hard braking as are applied to hard accelerations.

The table further includes an HC_I column (216), an HC_F column (218), and an HC_D column (220) storing hard cornering intensity, frequency, and duration, respectively. Details of these columns are similar to those of the HA_I column (204), HA_F column (206), and HA_D column (208). Indeed, a hard cornering intensity is also measured in meters per second squared (and subsequently may be converted to gs), and hard cornering duration is also measured in seconds. In general, however, hard cornering may be measured by monitoring accelerations perpendicular to the direction of travel. Otherwise, the same techniques may be applied to monitoring hard braking as are applied to hard accelerations.

Finally, the table includes a speed column (222). In the illustrated embodiment, the speed column (222) contains baselines (updated with a potentially variable periodicity) for aggregate vehicle speed on a given roadway segment.

As discussed, the values stored in the rows and columns may be updated as vehicles travel on the roadways. Thus, the values may be constantly and frequently changing (according to a potentially variable periodicity). In some embodiments, incoming data is buffered in a raw data store before processing and updating the table (200). In one embodiment, the data in the table (200) may be updated in real-time, while in other embodiments, the data in the table (200) may be updated in a batch process (e.g., according to the variable periodicity).

In the illustrated embodiment, the table (200) may further include more or fewer columns than those illustrated. Indeed, the table (200) may include any numeric value representing an event on a roadway. Such values may further include derived values.

As one example, a vehicle may be equipped with an inward-facing dash cam that records drivers. This dashcam may be equipped with an object detection model that identifies instances of distracted driving (e.g., driving while using a mobile phone).

In another embodiment, an outward-facing dash cam can be used to detect the presence of external objects in the roadway segment (e.g., traffic, wildlife, other obstructions, etc.

In another embodiment, weather conditions may be monitored for each segment and various derived metadata, such as the frequency of precipitation, the presence of fog, or aggregate temperature readings, may be recorded and stored for each segment. Other examples of such environmental data include, but are not limited to, road surface conditions (e.g., ice, water, etc.), traffic conditions (e.g., traffic volume, etc.), and visibility (e.g., visibility distance, etc.). Such information gathered from the dashcam models and environmental data can be stored and aggregated in different ways (e.g., by calculating the likelihood, frequency, or conditioning on the events).

In one embodiment, the roadway data may be visualized in a GUI such as GUI (700). In the illustrated embodiment, the GUI includes a map portion (708). In one embodiment, the map portion (708) can be provided from a commercially available map provider (e.g., Open Street Map, Google Maps, etc.). In the illustrated embodiment, a roadway network is used to highlight known segments (702) of the roadway. In one embodiment, the roadway network is associated with the geographic coordinates of each segment, and thus the known segments (702) can be overlaid on the image tiles based on these coordinates.

In the illustrated embodiment, an active segment (704) is highlighted. For example, a user may touch or mouseover the segment to view properties of that specific segment. In one embodiment, each segment is associated with a segment identifier, and the selection of an active segment (704) causes a query for data associated with the segment identifier.

In response, the GUI (700) renders a dialog (706) that includes data associated with the segment. As illustrated, this data can include, but is not limited to, route information (e.g., road name, city/state/country, etc.), speed data (e.g., average speed, percentage of speeding violations), hard braking/acceleration/cornering rates, hard braking/acceleration/cornering intensities, hard braking/acceleration/cornering durations, the average number of traversals per day, and any other data recorded for the segment. As can be seen, this data may be extracted or derived from data stored in a table such as a table (200). In some embodiments, the GUI (700) may be configured to provide per-driver or per-vehicle data, as will be discussed below.

In some embodiments, table (200) is replicated for various vehicle classes. For example, passenger vehicles may record data in a table separate from commercial trucks. In one embodiment, a table exists for each class of vehicles, wherein a class comprises a standardized stratification of vehicles (e.g., eight classes as defined by weight by the U.S. Department of Transportation Federal Highway Administration).

In one embodiment, the table (200) is only populated with data when sufficient telematics data is received. Thus, in some embodiments, a road segment will only be added to the table when the number of recorded measurements is above a triggering threshold. In some embodiments, if a given road segment does not have enough data, data from adjacent segments (referred to as 1-degree neighbor segments) may be used to populate data for the segment. Returning to FIG. 1, if segment (C) does not have enough data to reach the trigger threshold, the data from one or more segments (A, B, and D) can be used as data for segment (C). In some embodiments, this operation is recursive. That is, a centralized system will continue to expand its search (e.g., to 2-degree neighbor segments, 3-degree neighbor segments, etc.) until enough data is identified to meet the triggering threshold. Other algorithmic means of populating data for these sparse segments can also be used.

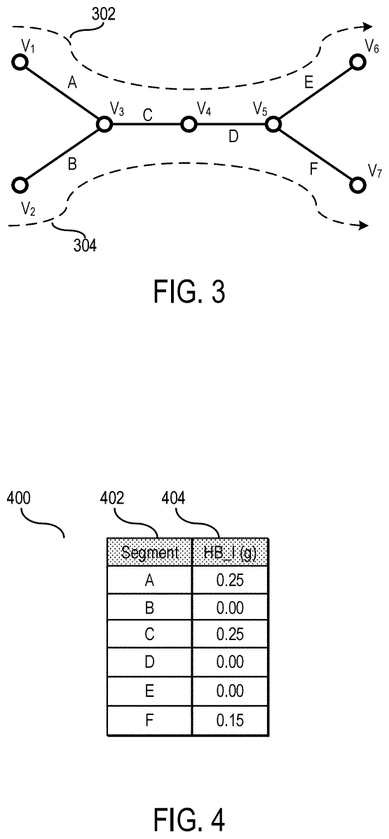

FIG. 3 is a diagram of a road network and driver paths according to some embodiments of the disclosure.

The illustrated roadway network includes the same segments (A-F) and vertices (v₁-v₇) as that depicted in FIG. 1, and the disclosure regarding the roadway provided in FIG. 1 is not repeated herein.

As illustrated, two driver paths are illustrated, including a first driver path (302) and a second driver path (304). The first driver path (302) can be represented as a sequence of segments driven on by the first driver: A→C→D→E. Similarly, the second driver path (304) can be represented as the sequence B→C→D→F. Alternatively, the vertices (v₁-v₇) can be used to represent the first driver path (302) and second driver path (304).

In general, the illustrated diagram shows two driver paths, wherein the first driver path (302) and second driver path (304) both indicate the respective drivers have traveled on segment (C) and segment (D). Conversely, only the first driver path (302) includes segment (A) and segment (E), and only the second driver path (304) includes segment (B) and segment (F).

The disclosed embodiments are not limited to two paths, and, as will be illustrated, any arbitrary number of paths can be recorded and used. Indeed, the greater the number of paths, the more data captured, and the more accurate modeling can be.

The following FIGS. 4 through 6 illustrate the use of the first driver path (302) and second driver path (304) and data collected thereon to update a table (200) of roadway data. The following FIGS. 4 through 6 utilize the HB_I column (210) of the table (200) illustrated in FIG. 2 as an example. However, the same techniques can be applied to any other type of column, as discussed.

FIG. 4 is a database diagram of two columns of a roadway data table according to some embodiments of the disclosure.

In the illustrated embodiment, a view (400) of a table, such as a table (200), is depicted as including two columns: a segment column (402) and an HB_I column (404) representing the average hard braking intensity along a segment. The view (400) can comprise a partial view of a larger table, such as a table (200). Indeed, segment column (402) can correspond to segment column (202) of FIG. 2, and HB_I column (404) can comprise HB_I column (210) of FIG. 2.

As discussed in connection with FIG. 3, as drivers travel on the roadway, hard braking events are transmitted to a centralized system. Based on, for example, a global positioning system (GPS) and a vehicle or driver identifier, the centralized system can store a list of such events associated with both drivers and segments (A-F).

For example, a first driver (ID=1) traveling along segment A may transmit the following hard break events:
A, 1609528495,1,0.15
A, 1609528555,1,0.25
A, 1609528615,1,0.30
A, 1609528675,1,0.30

Here, the first value (A) represents the segment, the second value (e.g., 1609528495) represents a timestamp (e.g., in Unix epoch time), the third value (1) represents a driver identifier, and the final value (e.g., 0.15) represents the hard brake intensity (in g-force). The centralized system can compute the average of all recorded data for segment A (0.25) and store this value in the HB_I column (404) for segment (A). Similarly, the centralized system may not receive any hard braking data for segment (B) and may record a value of 0.00 in the HB_I column (404).

Certainly, many segments will have data from multiple drivers. For example, for segment (C), the centralized system may receive the following data:
C, 1609528495,2,0.29
C, 1609528555,2,0.21
C, 1609615075, 1,0.25

As discussed, the format of this data can include the segment, timestamp, driver identifier, and hard braking intensity value. The centralized system can then average the values and write this average (0.25) as the value for the HB_I column (404) of segment (C). Certainly, the above data points may not be received simultaneously, and so the aggregate baseline values are updated in a batch manner with a potentially variable periodicity including in real-time. Further, although averages are used, these calculations are exemplary and other aggregation techniques can be used to calculate the values.

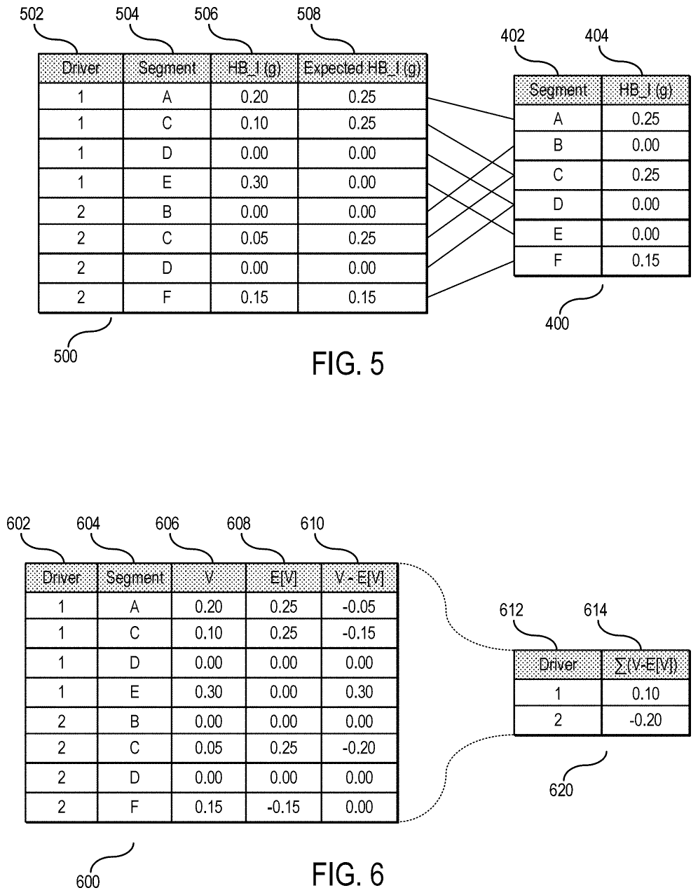

In the illustrated embodiment, each column of the table (200) is continuously updated (either in a batch mode, or in real or near real-time) in this manner based on received data. In some embodiments, the table (200) can be continuously updated during a preconfigured window length (e.g., 30 days). After the window length expires, the historical data may be recorded for historical analysis. In some embodiments, the table (200) may then be truncated or erased and reset for further accumulation. In other embodiments, the table may simply be continuously updated and refined without truncating data. Ultimately, the data in the table (200) may be considered an expected value for a corresponding column and row. Thus, returning to FIG. 4, the expected hard braking intensities, in g-forces, for segments A through F are 0.25, 0.00, 0.25, 0.00, 0.00, and 0.15, respectively. These expected values can then be used to compute deviations for individual drivers, as discussed next in connection with FIG. 5.

FIG. 5 is a database diagram of two driver paths and a view of a roadway data table according to some embodiments of the disclosure.

In the illustrated embodiment, a view (400) is depicted. This view (400) comprises the view (400) described in FIG. 4, and the description of the view (400) is not repeated herein.

In the illustrated embodiment, a table (500) stores data associated with driver activity. In the illustrated embodiment, the table (500) stores data associated with the first driver path (302) and the second driver path (304) depicted in FIG. 3. As discussed, the first driver path (302) includes segments A→C→D→E while the second driver path (304) includes segments B→C→D→F. Thus, these eight segments are stored as eight rows in the table (500). Although illustrated as rows in, for example, a relational table, the disclosed is not limited to such an implementation and other storage mechanisms (plaintext, NoSQL, log-based, etc.) may be used.

In the illustrated embodiment, the table (500) includes a driver identifier column (502) that identifies each driver or vehicle that has reported data for a segment. The table (500) additionally includes a segment column (504) that identifies a road segment that the driver (e.g., 1 or 2) or vehicle has driven on. In some embodiments, these fields may uniquely identify a given data point reported by a driver or vehicle. In some embodiments, the table (500) may further include a timestamp column (not illustrated) that further uniquely identifies the reported data. In some embodiments, this timestamp may comprise a time window as the remaining data is aggregated over a period of time. In some embodiments, the table (500) may be ephemeral and thus only store driver data for a short period of time (e.g., immediately after exiting a segment and for only as much time needed to process the data). Thus, in some embodiments, the driver identifier column (502) and segment column (504) are sufficient to uniquely identify a segment of a driver's path.

In the illustrated embodiment, the table (500) includes an observed HB_I column (506). In the illustrated embodiment, the observed HB_I column (506) reflects an individual driver's hard braking intensity (in, for example, g-forces) on a given segment. As such, the value stored in the observed HB_I column (506) may be aggregated for each segment.

In the illustrated embodiment, the table (500) further includes an expected HB_I column (508), which represents the average hard braking intensity for a given segment. In the illustrated embodiment, the values in the expected HB_I column (508) may be extracted from the roadway data, such as view (400). In one embodiment, the expected values may be copied into the table (500) to enable a log of what the expected value was at the time of recording (since the expected value will change over time). Thus, the table (500) can be self-contained for later processing while roadway data, including data in view (400), can be continuously updated. The hard brake intensity values are thusly collected and can be aggregated with a potentially variable periodicity to produce the baselines (i.e. expected values) table.

Although only hard braking intensity data is illustrated, the above process may be repeated for all measurable metrics. In one embodiment, the table (500) can be expanded to include additional column pairs for recorded and expected data. In another embodiment, separate tables may be used for each column pair (e.g., a second table for hard acceleration intensity, a third table for hard acceleration frequency, etc.).

FIG. 6 is a database diagram of two driver paths and a view of a roadway data table according to some embodiments of the disclosure.

In the illustrated embodiment, the driver identifier column (602) and segment column (604) correspond to the driver identifier column (502) and segment column (504) in FIG. 5, and those details are not repeated herein.

In the illustrated embodiment, the table (600) includes a value column (606) and an expected value column (608). In one embodiment, the data in the value column (606) and expected value column (608) correspond to the values populating the HB_I column (506) and expected HB_I column (508) of FIG. 5, and those details are not repeated herein. However, as indicated, the table (600) may be generalized for any measurable metric and is not limited to hard brake intensity, thus the use of “value” and “expected value” in lieu of “hard braking intensity” and “expected hard braking intensity”.

In the illustrated embodiment, the table (600) further includes a deviation column (610). In the illustrated embodiment, the deviation column (610) is populated by calculating the difference between the value column (606) data and the expected value column (608) data. Thus, for the first row (driver 1, segment A), the deviation is computed by subtracting 0.25 from 0.20, yielding −0.05.

Thus, for each driver and each driven segment, the table (600) stores a deviation from an expected value for each type of measurement. From this per-segment data, a per-driver score for the relevant metric can be calculated.

Specifically, as illustrated in the table (620), each driver can be associated with a second driver identifier column (612). In the illustrated embodiment, the second driver identifier column (612) is processed such that, for a given metric, each driver identifier is associated with a single row.

Further, as illustrated, each driver identified in the second driver identifier column (612) is associated with a component column (614) value. In the illustrated embodiment, the component column (614) is populated by aggregating all deviations stored in the deviation column (610) for a given driver. Thus, as illustrated, the component column (614) for driver 1 is computed by summing the values in the deviation column (610) for the first four rows (−0.05+−0.15+0.00+0.30=0.10).

Thus, in the illustrated embodiments, raw data associated with drivers is continuously received, processed, and summarized in per-metric component. While the foregoing examples use hard braking intensity as an example, the above example may be extended to various other parameters. A generalized description of the above method is provided next in combination with FIG. 8.

FIG. 8 is a flow diagram illustrating a method for continuously updating a driver or vehicle score according to some embodiments of the disclosure. Various terms and concepts that have been described with respect to the preceding Figures are not repeated in detail herein, and reference is made to those Figures for further detail of such terms and concepts.

In the illustrated embodiment, the method (800) may be executed by a centralized system such as a cloud computing platform or server. In some embodiments, the method (800) is executed at regular intervals (e.g., every day, every 30 days, etc.).

In step 802, the method (800) receives and stores raw data. In some embodiments, the raw data can comprise telematics data (e.g., speed, hard braking, hard cornering, hard accelerations) as described in, for example, the description of FIG. 2. In some embodiments, the raw data further comprises recorded images or video. In some embodiments, these images and videos are captured by outward-facing or inward-facing cameras installed on a vehicle. In other embodiments, the image or video may comprise any images or videos of vehicles, such as accident footage. The raw data can be associated with a roadway and, specifically, with a specific segment of a roadway.

In some embodiments, the method (800) receives the raw data from computing devices installed onboard vehicles. In some embodiments, these computing devices may comprise integrated computing devices (i.e., devices installed by the manufacturer of the vehicle) or after-market computing devices. In some embodiments, the vehicles comprise a fleet of non-autonomous vehicles. In other embodiments, the vehicles may comprise a fleet of autonomous vehicles. In some embodiments, both autonomous and non-autonomous vehicles may be mixed in a fleet.

In some embodiments, the method (800) stores the raw data in a data warehouse, data lake, or another high-capacity storage system. In general, the method (800) may store the data with no or minimal processing to ensure that as much data is recorded as possible.

As illustrated, the method (800) may operate two subprocesses in parallel. In the first model parameter generation subprocess (818), the method (800) generates model parameters based on accident and dashcam data. In one embodiment, the model parameters can comprise a weight vector, however, the disclosure is not limited to weight vectors, and indeed, the model parameters may comprise any arbitrary-dimensional array of numbers including, but not limited to, a matrix used in a decision tree, hyperparameters of one or more layers of a neural network, etc. In the second deviation subprocess (820), the method (800) normalizes telematics and other deviation data to generate an instantaneous deviation vector. The outputs of both sub-processes are then combined to generate a final score, as will be discussed.

In the model parameter generation subprocess (818), the method (800) first receives accident and dashcam data as well as measurement data in step (808). In one embodiment, the accident and dashcam data comprise image and video data associated with vehicular accidents or near-miss events. In one embodiment, the accident and dashcam data are manually labeled as such to assist in training. In one embodiment, the accident and dashcam data are further associated with measurement data, such as telematics and other data, as discussed above. In one embodiment, this measurement data is identical or overlapping in structure to the raw data processed in the deviation subprocess (820). For example, a given image or video may be associated with telematics data (e.g., hard acceleration, braking, etc.) recorded simultaneously with the image data. In one embodiment, both the measurement data and images/video are timestamped and stored in step 802. A reviewer then reviews the images/video to determine if an accident or, more commonly, a near-miss has occurred. If so, the measurement data is labeled as such. Thus, in step 808, the method (800) comprises generating a labeled measurement data training set. As will be discussed, the labeled training data can be used by a statistical learning methodology to learn an array of parameters (i.e., a weight tensor).

In some embodiments, the method (800) may use raw measurement data in step 808. However, in other embodiments, the method (800) may use deviations instead. In this embodiment, illustrated by a dotted line from step 804, the method (800) provides a driver's deviation from an expected value for a plurality of metrics (e.g., hard acceleration intensity, hard braking duration, etc.) as the measured data associated with images/video. In either scenario, the measured data associated with images/video is referred to as an input training vector.

In step 810, the method (800) normalizes the measurement data. In one embodiment, individual metrics can vary significantly. Thus, the method (800) normalizes the measurement data in step 810 to allow different methods to be compared in approximately the same numerical range. In one embodiment, the method (800) calculates z-scores for each measurement metric. Thus, the method (800) will calculate z-scores for hard acceleration intensity, hard acceleration frequency, etc. In one embodiment, a z-score (xₘ) for a metric (m) is calculated according to:

$${x}_{m} = \frac{X - {\overline{X}}_{m}}{{s}_{m}} \qquad ( Equation 1 )$$

where X represents the raw metric score for metric m, X̅ₘ represents the mean of all measurements for metric m, and sₘ represents the standard deviation of all measurements for metric m. In some embodiments, the window of data considered in the row set used to compute the sample mean and variance is potentially variable.

Thus, after step 810, the training data may be represented via a feature vector (V) having the form:

V=[L,x_{m,1},x_{m,2}, . . . x_{m,n}] (Equation 2)

where L represents the label (e.g., for accidents/near miss detection), x_{m,1} represents the z-score for feature 1, x_{m,2} represents the z-score for feature 2, and x_{m,n} represents the z-score for feature n. The set of all vectors generated in step 810 is referred to as the set of training examples ( [symbol] ).

In step 812, the method (800) determines model parameters based on the set of training examples ( [symbol] ). In one embodiment, the method (800) performs a statistical learning model (e.g., a logistic regression model) on the set [symbol] to generate the model parameters. In one embodiment, these parameters are represented as a vector:

$$W = [ \begin{matrix}{w}_{1} \\ {w}_{2} \\ ⋮ \\ {w}_{n}\end{matrix} ] \qquad ( Equation 3 )$$

where wᵢ represents a parameter (e.g., weight) for a corresponding measured data point.

In one embodiment, the number of model parameters is equal to the number of feature vectors in the set [symbol] . Thus, if the number of metrics is n, the number of model parameters is equal to n+1. In one embodiment, stochastic gradient descent is used to determine the model parameters based on the set [symbol] . In some embodiments, other constraints imposed by domain knowledge, such as the fact that certain parameters can be expected to be positive, can be enforced by the model training procedure.

The foregoing example of using accident/dashcam footage to estimate model parameters is exemplary only. Indeed, other techniques may be used to generate model parameters corresponding to measured features, and the foregoing example is not intended to unduly limit the overall process. In the illustrated embodiment, a deviation subprocess (820) is executed in parallel to compute deviation vectors for drivers.

In step 804, the method (800) generates a deviation vector (V_{D}) from raw data. This process was described in the description of FIGS. 1 through 6 and is not repeated herein in detail. In brief, for a given sampling period (e.g., one week), the method (800) computes an expectation vector, each element of the vector corresponding to a measurable data point (e.g., hard braking frequency, speed, etc.). The method (800) then compares a driver's performance (represented as a current vector) to the expected vector to compute a deviation vector which is the subtraction of the expected vector from the current vector. In the following description, the deviation vector is represented as:

$${V}_{D} = [ \begin{matrix}{d}_{1} \\ {d}_{2} \\ … \\ {d}_{n}\end{matrix} ] \qquad ( Equation 4 )$$

where dᵢ=mᵢ−eᵢ, mᵢ is the measured value of the ith measurable data point, eᵢ is the expected value of the ith measurable data point, and i∈ [symbol] : i∈[1, n].

In step 806, the method (800) normalizes the deviation vector V_{D}. In one embodiment, individual deviations can vary significantly, which can allow one or a few standard deviations to unduly influence a driver-level aggregation of these deviations. Thus, the method (800) normalizes the deviation vector in step 806 to prevent one or a few observations from overwhelming the others. In one embodiment, the method (800) applies a normalizing transformation by calculating z-scores for each deviation value dᵢ. Thus, the method (800) will calculate z-scores for the deviations in hard acceleration intensity, hard acceleration frequency, etc. In one embodiment, a z-score (xₘ) for a metric (m) is calculated according to Equation 1.

In step 814, the method (800) generates a driver update value. In one embodiment, the method (800) generates the driver update value by computing the dot product of the deviation vector V_{D} and the model parameters W as described with respect to Equations 3 and 4. In some embodiments, the method (800) may further apply a sigmoid squashing function to the dot product result. In general, the sigmoid squashing function may comprise any sigmoid function that ensures that the dot product output falls within a predefined range (e.g., −1 to 1). Thus, the driver update (X_{T}) can be represented as follows:

$${X}_{T} = σ ( {V}_{d} \cdot W ) = σ ( [ \begin{matrix}{d}_{1} \\ {d}_{2} \\ … \\ {d}_{n}\end{matrix} ] \cdot [ \begin{matrix}{w}_{1} \\ {w}_{2} \\ … \\ {w}_{n}\end{matrix} ] ) = σ ( {\sum }_{i = 1}^{n} {d}_{i} {w}_{i} ) \qquad ( Equation 5 )$$

where σ represents a sigmoid squashing function.

In step 816, the method (800) computes a new driver score using the driver update value from Equation 5 and the driver's previous score. In one embodiment, the method (800) calculates the new driver score by bounding the new score, providing edge resistance, and facilitating score surprise. In some embodiments, score surprise can be defined as a feature of the score wherein updates that deviate from our expectation result in more drastic score changes. For example, an equivalently positive update should increase the score of a driver with a lower score more than it would increase the score of a driver with a higher score since a driver with a higher score is expected to receive a positive update. These features are described in more detail here and may be represented via the following equation:

$${S}_{t} = \{ \begin{matrix}{S}_{t - 1} + ⌊ η \cdot ( 100 - {S}_{t - 1} ) \cdot ( 0.5 - σ ( {X}_{T} ) ) ⌋ , {X}_{T} \leq 0 \\ {S}_{t - 1} - ⌊ η \cdot {S}_{t - 1} \cdot ( σ ( {X}_{T} ) - 0.5 ) ) ⌋ , {X}_{T} > 0\end{matrix} \qquad ( Equation 6 )$$

where Sₜ represents the new driver score, Sₜ₋₁ represents a current stored driver score, η represents a tunable learning rate, and X_{T} represents the driver update value computed using, for example, Equation 5 and where σ represents a sigmoid squashing function. Note that the value of 100 shown above is the maximum score in this exemplary case but the maximum value can be any positive real number.

As illustrated in Equation 6, the new driver score (Sₜ) is a function of the previous driver score Sₜ₋₁. When X_{T} is less than or equal to zero, it is considered a positive update as the driver has performed more poorly in aggregate across the input dimensions than expected. In this case the previous driver score Sₜ₋₁ is incremented by a calculated amount. This calculated amount is the product of the learning rate (η), which is tunable, an edge resistance (100−Sₜ₋₁) and a bounding parameter 0.5−σ(X_{T}). In Equation 6, the learning rate comprises a tunable constant. In some embodiments, the learning rate is greater than zero but less than or equal to one. The edge resistance comprises a value between a minimum (e.g., 0) and maximum (e.g., 100). As illustrated, the edge resistance during a positive update reduces the magnitude of the update value as the previous score approaches the maximum (e.g., 100). This limits the impact of the increment as the previous score approaches this maximum value and consequently makes it increasingly difficult to reach this value.

Conversely, the bounding parameter makes it increasingly difficult to reach a score value of zero. Again, in some embodiments, zero is the minimum value in this exemplary embodiment—any real value less than the aforementioned maximum value can be employed. Specifically, when X_{T}≤0 the sigmoid output of X_{T} will be less than 0.5 but greater than 0. Thus, the bounding parameter will be between 0 (for a typical deviation vector) and 0.5 (for an exceptional deviation vector).

When X_{T}>0, the update is considered a negative score update as the driver has performed more poorly in aggregate across the input dimensions than expected. In this scenario, an edge resistance of Sₜ₋₁ is applied. Since this edge resistance is proportionate to the previous score, it reduces the negative impact of a poor driver update on a lower score and thus does not overly penalize drivers with already low scores. Similarly, a bounding parameter of σ(X_{T})−0.5 is applied. Since the value of X_{T} is greater than zero, the value of σ(X_{T}) will be greater than 0.5 but less than one. In this manner, the effect of the driver update is dampened in the opposite direction of the previous bounding parameter.

The foregoing example in Equation 7 is exemplary only and is not unduly limiting. Other score update techniques may be used to increment a previous score based on a vector of measurements. Further, the techniques for performing edge resistance and bounding are exemplary only, and other techniques may be used.

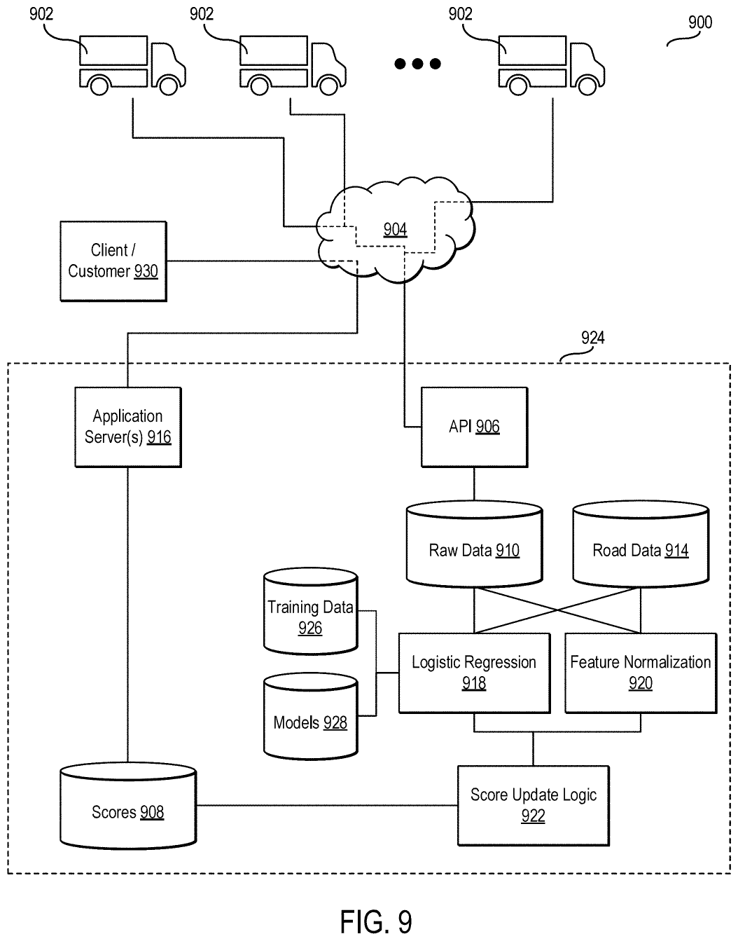

FIG. 9 is a block diagram of a system (900) for computing a driver score according to some embodiments of the disclosure.

In the illustrated embodiment, a plurality of vehicles (902) is communicatively coupled to a centralized system (924) via a network (904) such as the Internet. In one embodiment, each of the vehicles (902) includes a wireless transceiver for transmitting and receiving data over the network (904). For example, each of the vehicles (902) may include a cellular transceiver for transmitting and receiving data. In the illustrated embodiment, the vehicles (902) may be equipped with computing devices for monitoring vehicular performance. In some embodiments, these computing devices may be embedded in the vehicle or may comprise after-market additions. In general, such devices record telematics data of the vehicles, as discussed above, and in some embodiments other data such as video, images, weather reports, etc. In the illustrated embodiment, the vehicles (902) transmit data gathered by the computing devices to the centralized system (924) via the network (904). In one embodiment, the vehicles (902) stream this data to the centralized system (924). In other embodiments, the vehicles (902) periodically transmit data in batches to the centralized system (924).

The centralized system (924) includes an application programming interface or API (906). In the illustrated embodiment, the API (906) receives all data from the vehicles (902) and may comprise a load balancing server or similar device/software. In the illustrated embodiment, the API (906) writes the received data to a raw data store (910). The API (906) may perform any other functions such as user authentication, timestamping, duplicate removal, etc., which are not critical to understanding the disclosed embodiments.

In one embodiment, the raw data store (910) may comprise a big data storage platform such as a distributed database or file system. In some embodiments, the API (906) writes data directly to the raw data store (910). In other embodiments, the raw data store (910) may pre-process or clean the raw data prior to persisting. In some embodiments, the raw data store (910) comprises a data lake that stores arbitrary files (text, image, video, etc.). In other embodiments, the raw data store (910) may comprise a variegated data store wherein data types are routed to appropriate underlying sub-storage devices. For example, textual data may be stored in a log-structured or relational database, while image and video may be written to a distributed file system. The specifics of the underlying storage mechanism of the raw data store (910) are not limiting.

In the illustrated embodiment, a score update logic (922) runs continuously to update scores stored in the score database (908). In the illustrated embodiment, the score database (908) comprises a set of driver or vehicle identifiers mapped to scores and, in some embodiments, to companies or organizations. The score update logic (922) executes periodically (e.g., every day, week, month, etc.) and updates scores or some or all of the driver/vehicle identifiers in the score database (908).

In the illustrated embodiment, the score database (908) utilizes a logistic regression model (918) and feature normalization module (920) to generate a new score. In the illustrated embodiment, the regression model (918) receives input from training data (926), models (928), raw data store (910), and road data store (914). In one embodiment, the models (928) include current model parameters and, in some embodiments, historic model parameters. Models (928) may additionally include learning rates and other tunable parameters used by the logistic regression model (918) and score update logic (922). In one embodiment, training data (926) comprises labeled and timestamped video or image data depicting near miss or accident conditions. In some embodiments, the data in training data (926) is correlated with raw data stored in the raw data store (910). Thus, in some embodiments, the regression model (918) augments raw data with labels generated based on the data in training data (926). In some embodiments, the regression model (918) may receive road data from the road data store (914). In one embodiment, the road data store (914) stores details of the geometry of the road network (e.g., road identifiers, average weather conditions, etc.). In some embodiments, the regression model (918) uses the road data to generate expectation vectors for the raw data. In alternative embodiments, the regression model (918) may receive this data from the feature normalization module (920). In the illustrated embodiment, the regression model (918) outputs model parameters. In one embodiment, the dimensions of the model parameters are equal to the measurement vectors output by the feature normalization module (920), as will be discussed. In general, the model parameters describe the relative importance of measurements based on near-miss or accident data.

In the illustrated embodiment, the feature normalization module (920) receives raw data and road data and outputs a deviation vector for a given driver. For example, the feature normalization module (920) may receive a set of raw metrics for a given set of road segments, may aggregate the data to form a measurement vector for each measurement type, and then may compute z-scores for the measurement vector.

Various details of the regression model (918) and feature normalization module (920) have been described previously. Specifically, FIGS. 1 through 6 and steps 804 and 806 of FIG. 8 may be performed by the feature normalization module (920), and steps 808, 810, and 812 of FIG. 8 may be performed by the logistic regression model (918). Those descriptions are not repeated herein but are incorporated in their entirety. Further, although the illustrated embodiment describes the use of a logistic regression model, other models may be used, as previously discussed.

In the illustrated embodiment, the score update logic (922) receives a measurement vector and model parameters from the feature normalization module (920) and logistic regression model (918), respectively. In one embodiment, the score update logic (922) computes a dot product of the two vectors and applies a sigmoid function to the result. In some embodiments, the score update logic (922) then applies a learning update rule to the result of the sigmoid operation to obtain a new score. Finally, the score updater (922) updates the score database (908) with the new score for a given driver/vehicle. In some embodiments, the score database (908) maintains a historical log of scores on a per-driver basis when the scores are updated, thus allowing audit tracking. Details of this process are described in more detail in the description of steps 814 and 816 of FIG. 8, and that description is not repeated herein but is incorporated in its entirety.

In the illustrated embodiment, application servers (916) access the score database (908) to retrieve scores for drivers or vehicles. In one embodiment, the application servers (916) provide end-user functionality to clients (930) based on the scores in the score database (908). Thus, in some embodiments, the application servers (916) may comprise a web server providing a web-based interface providing various functions. Alternatively, or in conjunction with the foregoing, the application servers (916) may comprise web APIs providing data to mobile applications. The disclosed embodiments are not limited to specific client-facing applications, however various examples of such client-facing applications are provided herein.

In one embodiment, the application servers (916) may provide an application (or data for an application) that allows safety managers and drivers alike to contextualize and act upon factors that affect their safety in a timely manner. To make the insights that the score provides easier to operationalize, the application servers (916) may implement artificial intelligence (AI) powered safety coaching workflows that take the score as one of the primary inputs. In such a system, a client (930) may access the application servers (916) to set time-bound goals per driver or group of drivers associated with scores in the score database (908). These goals could either be target scores to attain or targets (e.g., Stretch Goal, Maintain Goal) that the centralized system (924) translates into scores. In one embodiment, the application servers (916) suggest scores based on score history and other aspects of driving behavior. Next, the application servers (916) can generate concrete action plans (in terms of driver behavior) in order to achieve these goals using a combination of AI and score dynamics. The application servers (916) will then display both these goals and the progress being made towards them along the dimensions suggested by the action plan. In conjunction with manual intervention by safety managers, the application servers (916) can recommend coaching material for drivers to review if progress towards goals is deemed insufficient. Incentive structures can be built into the application servers (916) that facilitate the disbursement of awards to drivers who meet safety goals within the time bound of the goal. The cycle then repeats.

In another embodiment, the application servers (916) may be used by insurance clients (930) to gauge driver risk based on stored scores. In one embodiment, the application servers (916) may provide score-based insurance products that can take the form of partnerships, data exchanges, and usage-based insurance (UBI) offerings, among others. Thus, insurance products can be narrowly tailored to individual drivers.

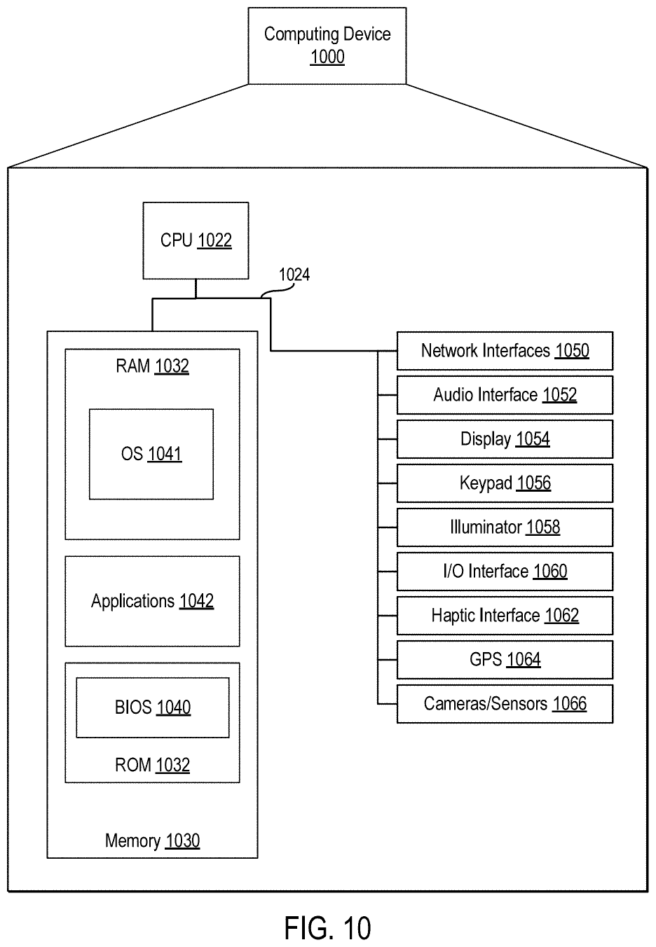

FIG. 10 is a block diagram illustrating a computing device showing an example of a client or server device used in the various embodiments of the disclosure.

The computing device (1000) may include more or fewer components than those shown in FIG. 10, depending on the deployment or usage of the device (1000). For example, a server computing device, such as a rack-mounted server, may not include an audio interface (1052), display (1054), keypad (1056), illuminator (1058), haptic interface (1062), Global Positioning System (GPS) receiver (1064), or cameras/sensor (1066). Some devices may include additional components not shown, such as graphics processing unit (GPU) devices, cryptographic co-processors, artificial intelligence (AI) accelerators, or other peripheral devices.

As shown in the figure, the device (1000) includes a central processing unit (CPU) (1022) in communication with a mass memory (1030) via a bus (1024). The computing device (1000) also includes one or more network interfaces (1050), an audio interface (1052), a display (1054), a keypad (1056), an illuminator (1058), an input/output interface (1060), a haptic interface (1062), an optional global positioning systems (GPS) receiver (1064) and a camera(s) or other optical, thermal, or electromagnetic sensors (1066). Device (1000) can include one camera/sensor (1066) or a plurality of cameras/sensors (1066). The positioning of the camera(s)/sensor(s) (1066) on the device (1000) can change per device (1000) model, per device (1000) capabilities, and the like, or some combination thereof.

In some embodiments, the CPU (1022) may comprise a general-purpose CPU. The CPU (1022) may comprise a single-core or multiple-core CPU. The CPU (1022) may comprise a system-on-a-chip (SoC) or a similar embedded system. In some embodiments, a GPU may be used in place of, or in combination with, a CPU (1022). Mass memory (1030) may comprise a dynamic random-access memory (DRAM) device, a static random-access memory device (SRAM), or a Flash (e.g., NAND Flash) memory device. In some embodiments, mass memory (1030) may comprise a combination of such memory types. In one embodiment, the bus (1024) may comprise a Peripheral Component Interconnect Express (PCIe) bus. In some embodiments, the bus (1024) may comprise multiple busses instead of a single bus.

Mass memory (1030) illustrates another example of computer storage media for the storage of information such as computer-readable instructions, data structures, program modules, or other data. Mass memory (1030) stores a basic input/output system (“BIOS”) (1040) for controlling the low-level operation of the computing device (1000). The mass memory also stores an operating system (1041) for controlling the operation of the computing device (1000)

Applications (1042) may include computer-executable instructions which, when executed by the computing device (1000), perform any of the methods (or portions of the methods) described previously in the description of the preceding Figures. In some embodiments, the software or programs implementing the method embodiments can be read from a hard disk drive (not illustrated) and temporarily stored in RAM (1032) by CPU (1022). CPU (1022) may then read the software or data from RAM (1032), process them, and store them to RAM (1032) again.

The computing device (1000) may optionally communicate with a base station (not shown) or directly with another computing device. Network interface (1050) is sometimes known as a transceiver, transceiving device, or network interface card (NIC).

The audio interface (1052) produces and receives audio signals such as the sound of a human voice. For example, the audio interface (1052) may be coupled to a speaker and microphone (not shown) to enable telecommunication with others or generate an audio acknowledgment for some action. Display (1054) may be a liquid crystal display (LCD), gas plasma, light-emitting diode (LED), or any other type of display used with a computing device. Display (1054) may also include a touch-sensitive screen arranged to receive input from an object such as a stylus or a digit from a human hand.

Keypad (1056) may comprise any input device arranged to receive input from a user. Illuminator (1058) may provide a status indication or provide light.

The computing device (1000) also comprises an input/output interface (1060) for communicating with external devices, using communication technologies, such as USB, infrared, Bluetooth™, or the like. The haptic interface (1062) provides tactile feedback to a user of the client device.

The optional GPS receiver (1064) can determine the physical coordinates of the computing device (1000) on the surface of the Earth, which typically outputs a location as latitude and longitude values. GPS receiver (1064) can also employ other geo-positioning mechanisms, including, but not limited to, triangulation, assisted GPS (AGPS), E-OTD, CI, SAI, ETA, BSS, or the like, to further determine the physical location of the computing device (1000) on the surface of the Earth. In one embodiment, however, the computing device (1000) may communicate through other components, provide other information that may be employed to determine a physical location of the device, including, for example, a MAC address, IP address, or the like.

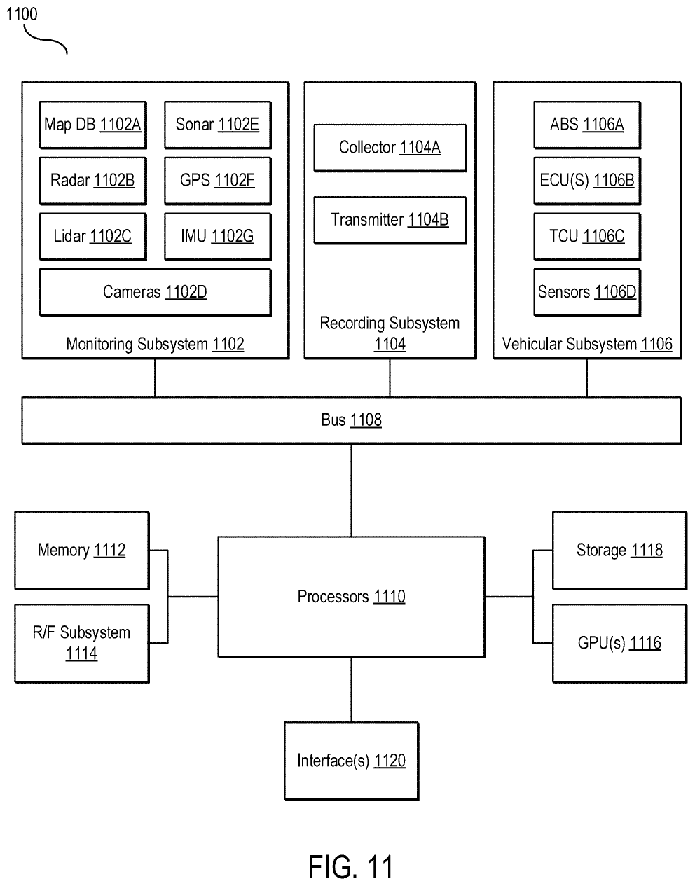

FIG. 11 is a block diagram of a vehicle according to some embodiments of the disclosure.

The system (1100) illustrated in FIG. 11 may be installed entirely within a vehicle. In some embodiments, some components (e.g., components and subsystems other than subsystem 1104) may comprise existing autonomous vehicle subsystems, although in some embodiments autonomous vehicle subsystems are optional. Thus, the vehicle in FIG. 11 may comprise either an autonomous, semi-autonomous or non-autonomous vehicle. Descriptions made herein are primarily described with respect to autonomous vehicles however this is not intended to be limiting.

In the illustrated embodiment, the system includes a monitoring subsystem (1102). In the illustrated embodiment, monitoring subsystem (1102) includes map database (1102A), radar devices (1102B), Lidar devices (1102C), digital cameras (1102D), sonar devices (1102E), global positioning system (GPS) receivers (1102F), and inertial measurement unit (IMU) devices (1102G). Each of the components of the monitoring subsystem (1102) comprise standard components provided in most current autonomous vehicles or ADAS. In one embodiment, map database (1102A) stores a plurality of high-definition three-dimensional maps used for routing and navigation. Radar devices (1102B), Lidar devices (1102C), digital cameras (1102D), sonar devices (1102E), GPS receivers (1102F), and inertial measurement units (1102G) may comprise various respective devices installed at various positions throughout the autonomous vehicle as known in the art. For example, these devices may be installed along the perimeter of an autonomous vehicle to provide location awareness, collision avoidance, and other standard autonomous vehicle or ADAS functionality. As discussed, in some embodiments, the monitoring subsystem (1102) may be optional or limited such as any form of an ADAS. For example, a non-autonomous vehicle may only include one camera device such as a dash-mounted camera device. In this embodiment, the camera may be included in the sensors (1106D).

Vehicular subsystem (1106) is additionally included within the system. Vehicular subsystem (1106) includes various anti-lock braking system (ABS) devices (1106A), engine control unit (ECU) devices (1106B), transmission control unit (TCU) devices (1106C), and various other sensors (1106D) such as heat/humidity sensors, emissions sensors, etc. These components may be utilized to control the operation of the vehicle. In some embodiments, these components perform operations in response to the streaming data generated by the monitoring subsystem (1102). The standard autonomous vehicle interactions between monitoring subsystem (1102) and vehicular subsystem (1106) are generally known in the art and are not described in detail herein.

The processing side of the system includes one or more processors (1110), short-term memory (1112), a radio-frequency (RF) system (1114), graphics processing units (GPUs) (1116), long-term storage (1118) and one or more interfaces (1120).

One or more processors (1110) may comprise central processing units, field-programmable gate arrays (FPGAs), or any range of processing devices needed to support the operations of the autonomous vehicle. Memory (1112) comprises dynamic random-access memory (DRAM) or other suitable volatile memory for temporary storage of data required by processors (1110). RF system (1114) may comprise a cellular transceiver and/or satellite transceiver. Long-term storage (1118) may comprise one or more high-capacity solid-state drives (SSDs). In general, long-term storage (1118) may be utilized to store, for example, high-definition maps, routing data, and any other data requiring permanent or semi-permanent storage. GPUs (1116) may comprise one or more high throughput GPU/VPU/TPU devices for processing data received from monitoring subsystem (1102). Finally, interfaces (1120) may comprise various display units positioned within the autonomous vehicle (e.g., an in-dash screen).

Each of the devices is connected via a bus (1108). In one embodiment, the bus (1108) may comprise a controller area network (CAN) bus. In some embodiments, other bus types may be used (e.g., a FlexRay or Media Oriented Systems Transport, MOST, bus). Additionally, each subsystem may include one or more additional busses to handle internal subsystem communications (e.g., Local Interconnect Network, LIN, busses for lower bandwidth communications).

The system additionally includes a recording subsystem (1104) which performs the operations required by the methods illustrated in the following Figures. In the illustrated embodiment, the recording subsystem (1104) includes a collector (1104A) that captures data recording by the monitoring subsystem (1102) and forwards relevant data to the transmitter (1104B) which packages the data for transmission to a centralized system (e.g., 924).

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
receiving metrics associated with a vehicle;
generating a deviation vector based on the metrics and a plurality of aggregated values corresponding to the metrics;
computing a driver update value based on the deviation vector and a plurality of model parameters, each of the plurality of model parameters corresponding to the metrics; and
computing a driver score based on the driver update value, a previous score, and a learning rate.

2. The method of claim 1, further comprising generating the aggregated values by:
receiving, for a plurality of road segments, corresponding metrics from a plurality of drivers; and
aggregating, for each of the plurality of road segments, the corresponding metrics.

3. The method of claim 2, wherein aggregating the corresponding metrics further comprises averaging the corresponding metrics.

4. The method of claim 2, wherein computing a driver update value based on the deviation vector comprises computing deviation values for each of the metrics, the deviation value computed by subtracting a corresponding aggregated value from the corresponding metric.

5. The method of claim 4, wherein computing deviation values for each of the metrics comprises:
selecting a plurality of road segments;
computing deviation values for the metric for each of the plurality of road segments; and
summing the deviations values to generate the deviation value for the metric.

6. The method of claim 1, further comprising calculating the model parameters via a statistical learning methodology.

7. The method of claim 6, wherein the statistical learning methodology is trained using a combination of video, telematics, and externally-obtained data.

8. A non-transitory computer-readable storage medium for tangibly storing computer program instructions capable of being executed by a computer processor, the computer program instructions defining steps of:
receiving metrics associated with a vehicle;
generating a deviation vector based on the metrics and a plurality of aggregated values corresponding to the metrics;
computing a driver update value based on the deviation vector and a plurality of model parameters, each of the plurality of model parameters corresponding to the metrics; and
computing a driver score based on the driver update value, a previous score, and a learning rate.

9. The medium of claim 8, the computer program instructions defining the step of: generating the aggregated values by:
receiving, for a plurality of road segments, corresponding metrics from a plurality of drivers; and
aggregating, for each of the plurality of road segments, the corresponding metrics.

10. The medium of claim 9, wherein aggregating the corresponding metrics further comprises averaging the corresponding metrics.

11. The medium of claim 9, wherein computing a driver update value based on the deviation vector comprises computing deviation values for each of the metrics, the deviation value computed by subtracting a corresponding aggregated value from the corresponding metric.

12. The medium of claim 11, wherein computing deviation values for each of the metrics comprises:
selecting a plurality of road segments;
computing deviation values for the metric for each of the plurality of road segments; and
summing the deviations values to generate the deviation value for the metric.

13. The medium of claim 8, the computer program instructions defining the step of calculating the model parameters via a statistical learning methodology.

14. The medium of claim 13, wherein the statistical learning methodology is trained using a combination of video, telematics, and externally-obtained data.

15. A device comprising:
a processor configured to:
receive metrics associated with a vehicle;
generate a deviation vector based on the metrics and a plurality of aggregated values corresponding to the metrics;
compute a driver update value based on the deviation vector and a plurality of model parameters, each of the plurality of model parameters corresponding to the metrics; and
compute a driver score based on the driver update value, a previous score, and a learning rate.

16. The device of claim 15, the processor further configured to generate the aggregated values by:
receiving, for a plurality of road segments, corresponding metrics from a plurality of drivers; and
aggregating, for each of the plurality of road segments, the corresponding metrics.

17. The device of claim 16, wherein aggregating the corresponding metrics further comprises averaging the corresponding metrics.

18. The device of claim 16, wherein computing a driver update value based on the deviation vector comprises computing deviation values for each of the metrics, the deviation value computed by subtracting a corresponding aggregated value from the corresponding metric.

19. The device of claim 18, wherein computing deviation values for each of the metrics comprises:
selecting a plurality of road segments;
computing deviation values for the metric for each of the plurality of road segments; and
summing the deviations values to generate the deviation value for the metric.

20. The device of claim 15, the processor further configured to calculate the model parameters via a statistical learning methodology.
